(19) United States
(12) Patent Application Publication
(10) Pub. No.: US 2010/0132561 A1
(43) Pub. Date: Jun. 3, 2010

(54) ELECTROSTATIC CHARGING AND COLLECTION

(75) Inventors: Leslie Bromberg, Sharon, MA (US); Ching Wu, Acton, MA (US); Mark A. Osgood, Brookline, NH (US)

Correspondence Address: CHING WU;Excellims Corporation, 20 Main Street, Acton, MA, 01720, US

(73) Assignee: Excellims Corporation, Acton, MA (US)

(21) Appl. No.: 12/698,047

(22) Filed: Feb. 1, 2010

Related U.S. Application Data
(63) Continuation-in-part of application No. 11/736,233, filed on Apr. 17, 2007.
(60) Provisional application No. 61/148,996, filed on Feb. 1, 2009.

(51) Int. Cl. B03C 3/011; H01J 49/02

(52) U.S. Cl. 96/54; 95/79; 95/80; 95/73; 96/62; 250/283

(57) ABSTRACT

The present invention describes directly using particles collected with an electrostatic precipitator for the detection of explosives and other compounds of interest. The method and apparatus of analyzing particles involves directly measuring particles on the collection electrodes or thermally desorbing them into an ion mobility spectrometer and/or other analytical instruments. One aspect of the present invention is a particulate charging method. Another aspect of the present invention provides a means of high charging of the particulates while minimizing their collection in the charging stage. The present invention also provides a means for efficiently collecting the particulates in a second stage for sampling in a compact electrode.

### CROSS-REFERENCE TO RELATED APPLICATIONS

The present application is a continuation in part of U.S. patent application Ser. No. 11/736,233, filed on Apr. 17, 2007, and claims the benefit of and priority to corresponding U.S. Provisional Patent Application Ser. No. 61/148,996, filed Feb. 1, 2009 respectively; the entire content of the application is herein incorporated by reference.

### BACKGROUND OF THE INVENTION

Electrostatic precipitators have been used in industrial settings for particulate control and environmental sampling. One way to differentiate electrostatic precipitators is whether they use single or two stage precipitators. In a single stage precipitator, both the charging of the particulates and their removal occurs in the same region of the electrostatic precipitator. In the two-stage configuration, charging of the particulates occurs at a different location from their removal.

Charging of the particulates is a function of: the ambient electric field, the background ion density, the charging time and the dielectric constant of the particulate. For periods of time that are longer compared with the charging time, the saturation charge in a particulate is a function of the electric field (for ion bombardment charging, which applies for particulates >0.1 microns). For smaller particulates, diffusion charging dominates, which is less a function of the ambient electric field but heavily dependent on the ion charge density.

Two stage precipitators have been in commercial use for many years for emission control and for particulate sampling. In these units, the charging of the particulates occurs in a first stage while in the second stage the particulates are precipitated or collected into electrodes or filters. The filters can be bags, fibrous filters or others. However, there is substantial drift and collection of the particulates in the charging stage.

There are multiple designs for increasing the charge on the particulates, including pulsed corona, the use of high electric fields with RF electrodes, and other arrangements. However, none of these designs prevent the collection of particulates in the charging stage. It is the purpose of this invention to overcome this obstacle.

### SUMMARY OF THE INVENTION

One aspect of the present invention is a particulate charging method comprising the following steps: charging a particulate gaseous stream, applying an AC waveform, inducing ions from an ionization source during a fraction of the AC waveform of a given polarity, and not inducing ions from the ionization source during a fraction of the AC waveform of a opposite polarity. A frequency can be applied to the AC waveform such that the particulates will not experience a substantial electric drift during each fraction of the AC waveform. The duty cycle of the fraction of the AC waveform that induces ions from an ionization source to that of the fraction of the AC waveform of opposite polarity and without ion scan being adjusted to substantially decrease the deposition of the particulates on either electrode in a charging section. Another aspect of the present invention, provides a means of high charging of the particulates while minimizing their collection in the charging stage. During the particulate charging method, the collection of particles is minimized during charging. Yet another aspect of the present invention provides a means for efficiently collecting the particulates in a second stage for sampling in a compact electrode. The particulate charging method may also include collecting particles. In addition, the collected particles can be heated in order to vaporize the particles. Also, theses particles and/or vapors can be analyzed.

The present invention also describes directly using particles collected with an electrostatic precipitator for the detection of explosives and other compounds of interest. The method and apparatus of analyzing particles involves directly measuring particles on the collection electrodes or thermally desorbing them into an ion mobility spectrometer and/or other analytical instruments.

### BRIEF DESCRIPTION OF THE DRAWINGS

The foregoing and other aspects, embodiments, and features of the inventions can be more fully understood from the following description in conjunction with the accompanying drawings. In the drawings like reference characters generally refer to like features and structural elements throughout the various figures. The drawings are not necessarily to scale, emphasis instead being placed upon illustrating the principles of the inventions.

FIG. 1 shows a wire-to-cylinder precipitator.

FIG. 2 shows one potential waveform.

FIG. 3 shows another potential waveform to illustrate that various electric waveforms are possible.

FIG. 4 shows the number of charges in a micron particle, for a high performance charging stage.

FIG. 5 shows a schematic diagram of sample collection in the second stage.

FIG. 6 shows the electrostatic charging apparatus being used in-conjunction with other analytical instruments.

FIG. 7 shows shows four charging and collection stages.

FIG. 8 shows the electrostatic charging section integrated into the handheld wand design.

### DETAILED DESCRIPTION OF VARIOUS EMBODIMENTS

As used herein, the term “analytical instrument” generally refers to ion mobility based spectrometer, MS, other spectroscopy and spectrometry and any other instruments that have the same or similar functions.

Unless otherwise specified in this document the term “ion mobility based spectrometer” is intended to mean any device that separates ions based on their ion mobilities or mobility differences under the same or different physical and chemical conditions and detecting ions after the separation process. Many embodiments herein use the time of flight type IMS, although many features of other kinds of IMS, such as differential mobility spectrometer and field asymmetric ion mobility spectrometer are included. Unless otherwise specified, the term ion mobility spectrometer or IMS is used interchangeable with the term ion mobility based spectrometer defined above.

Unless otherwise specified in this document the term “mass spectrometer” or MS is intended to mean any device or instrument that measures the mass to charge ratio of a chemical/biological compounds that have been converted to an ion or stores ions with the intention to determine the mass to charge ratio at a later time. Examples of MS include, but are not limited to: an ion trap mass spectrometer (ITMS), a time of flight mass spectrometer (TOFMS), and MS with one or more quadrupole mass filters.

The phrase “and/or,” as used herein in the specification and in the claims, should be understood to mean “either or both” of the elements so conjoined, i.e., elements that are conjunctively present in some cases and disjunctively present in other cases.

Unless otherwise specified in this document the term “chemical and/or biological molecule(s)” is intended to mean various particles, charged particles, and charged particles derived from atoms, molecules, particles, sub-atomic particles, and ions. The term “particle” and “particulate” are used interchangeably in this invention. In many method and apparatus descriptions, the term particle implies particles and/or vapor forms of sample.

Unless otherwise specified in this document the term “ion mobility based detector” is intended to mean any device that separates ions based on their ion mobilities or mobility differences under the same or different physical and chemical conditions and detecting ions after the separation process.

In one embodiment of the present invention, a system for particulate charging comprises a set of electrodes energized with an AC waveform and only one polarity of ions exist in the device from an ionization source during only one of the fractions of the AC waveform and there is substantially no ions during the remainder of the AC waveform of opposite polarity. The ionization source can be a corona or an electrospray, but not limited to only these. The AC waveform can be an asymmetric waveform. The DC level or time-average value of the AC waveform can be positive, negative or near neutral.

Many of the following aspects of the invention and/or examples of the invention use a corona as the ionization source. It is our intention to use an electrospray ionization source for these aspects of the invention and/or examples of the invention as well. Therefore the following information uses a corona, but it is to be understood that the corona could be replaced for an electrospray for the following aspects and/or examples.

In one aspect of the present invention, a high frequency asymmetric waveform is relied upon, such that there is corona discharge for the high field polarity but no corona for the low voltage of the opposite polarity. The asymmetric waveform has no time-averaged electric field, or a small net time-averaged electric field, to minimize self-charge precipitation. The frequency is high enough in order to prevent substantial drift of the particulates due to the applied electric fields during the fractions of the AC waveform of a given polarity. After a cycle of the AC waveform there is no net electric induced particulate motion. Alternatively, a small average field can be set so that the particulates either drift towards one or the opposite electrode, depending on the polarity of the time-averaged field. It is possible to adjust the time-averaged value of the electric field in order to minimize the deposition of particulates in the charging section.

The waveform is chosen such that during the longer fraction of the AC waveform the applied voltage is below the corona-starting voltage. It may be possible to have small current during this phase but the preferred embodiment has none. In addition, the polarity of the shorter duration, with the higher absolute value of the field, is chosen such that it has high current. For air, it may be preferred to use negative polarity, as this results in higher corona currents at a given voltage, and usually have, in air, higher spark-over voltages. Positive corona, on the other hand produce reduced amounts of ozone. However, the corona polarity, during the ionizing fraction of the AC waveform, can be a negative corona or a positive corona.

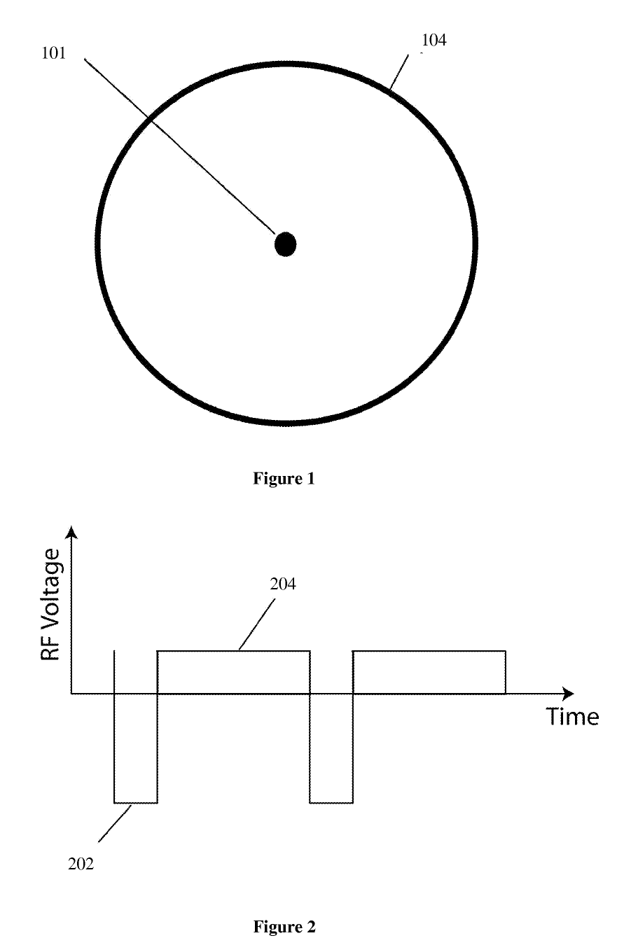

With respect to FIG. 1, the corona is generated in the thin wire 101 at the center, and ions with the same polarity as the thin wire electrode move towards the outer tube 104. The geometry is not limited to the example illustrated in FIG. 1, which is wire-to-cylinder. Any geometry where corona is generated to charge particulates that are entrained in a gaseous stream can be used by the present invention to charge the particulates without collection, such as parallel plate precipitators.

With respect to FIG. 2, a simple waveform is used to illustrate the concept. In FIG. 2, a top-hat like waveform generates negative corona during the short-duration 202 high intensity electric field, but there is no corona during the long-duration 204 low intensity positive electric field. As shown in FIG. 2, the average value of the electric field is 0. It is intended for this value to be small compared to the negative polarity.

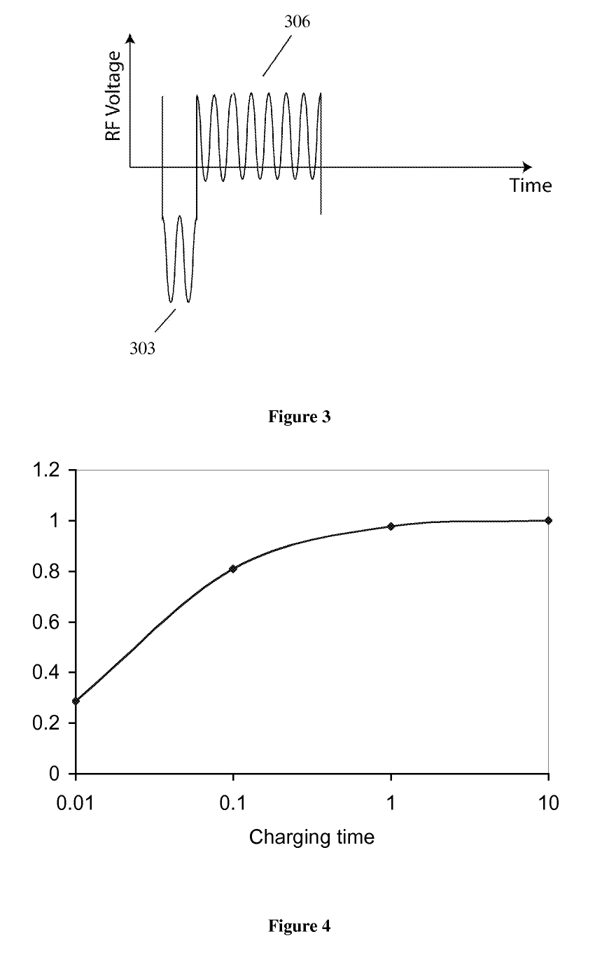

FIG. 3 illustrates a different waveform, where there is a high frequency AC superimposed on the asymmetric field. There is a short duration 303 and a long duration 306. The purpose is to illustrate that many waveforms can be used, as long as there is no or very little corona from one of the polarities and a strong corona from the other polarity, and the average value of the electric field is small.

FIG. 4 shows the time history of the number of charges in a 1 micron particle for an ion density of 5×1013/m3, and an electric field of 2 kV/cm. [Adapted from “Electrostatic Precipitation,” by Myron Robinson in Air Pollution Control, part 1, Werner Straus ed., Wiley Interscience pp 227-335 (1971)]. It should be noted the fast charging of the particulates to a ˜50-60% of the saturation charge (˜30 ms), and the slow asymptotic charging to >90% (>300 ms). Thus, if the collector is sufficiently aggressive, it should be possible to very substantially decrease the length (or residence time of the particulate-laden gaseous stream) of the charging stage while maintaining good collection characteristics in the downstream collection stage.

Although the mechanism operates well in air, it should be possible to add a reagent to the gaseous stream to alter the ion chemistry and modify the type of ions that are charging the particulates. Some reagents could be, but are not limited to: ammonia, alcohols, hydrocarbons, chlorinated compounds, amides, etc.

In case that the particulate density is small and the volumetric charge due to the particulates is small, the average value of the electric field should be zero or small. If it is slightly negative, the polarity indicated in FIG. 2 will result in limited collection in the outer surface. If slightly positive, there will be limited collection in the inner electrode for the case indicated in FIG. 2. It can be shown that the net loss of particulates to either electrode is dependent on the strength of the average electric field but independent of the polarity of the average field. This is the case when the particulate distribution is relatively uniform (a good assumption, as hydrodynamic turbulence determines the distribution of particulates), and as long as the space charge from the particulates themselves is small. Under those conditions, particulate collection in the sampling stage is minimized with 0 average field. If the self-space charge from the particulates is substantial, then there is an advantage to the existence of a small electric field that partially compensates for the net outward drift of the particulates. Thus, the value of the average electric field can be adjusted to minimize the particulate loss in the charging stage.

In one aspect of the invention, the frequency of the AC waveform needs to be chosen so that the particulate do not experience large drifts (compared with the size of the electrode gap) during the fraction of the AC waveform with a given polarity. Particulates of interest move with velocities of the order of fraction of meters/s. At a frequency of 10 kHz, assuming a AC waveform with 25% fraction of corona, the particulate motion is on the order of microns. At 200 kHz, the electric drift of the particulates is 1 micron.

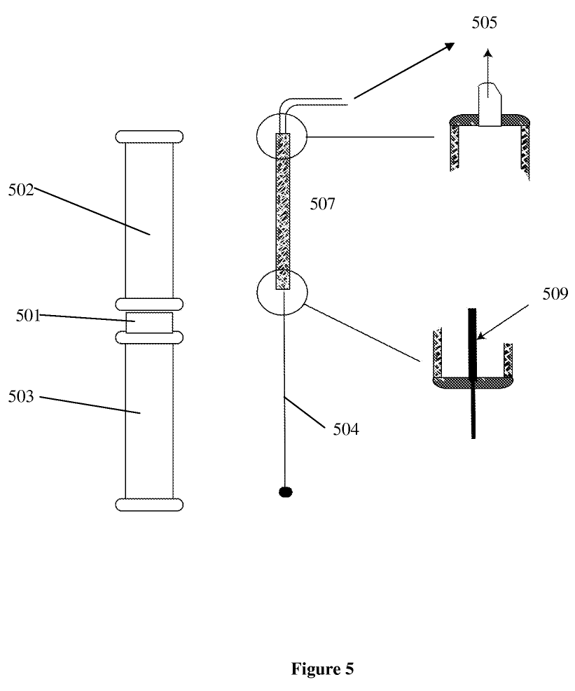

In another embodiment of this invention, a second stage can be used to for collecting the charged particulates by utilizing an appropriately directed electric field. The goal in many sampling concepts is to collect the sample in as small a surface or volume as possible, which would result in higher concentration of the sample, and thus easier detection/quantification. FIG. 5 shows a non-limiting example. FIG. 5 shows the use of one aspect of this invention to collect the particulates and then to generate a gaseous stream that can be directed to an analyzer 505, in particular an analytical instrument, a ion mobility spectrometer, a mass spectrometer, a detector, a sensor unit, GC, but not limited to only these. The radial direction of the electric field has been reversed in the second stage with respect to the electric field during the fraction of the AC waveform where the ionization occurs. Particulate(s) are collected on the collecting electrode 507, in particular the center electrode. The thin wire corona 504 is at ground potential. The collecting electrode can be porous. The collecting electrode can have a dielectric with a low negative voltage on one side 502 and a high positive voltage 503 on the other side. After heating the collecting electrode, the gaseous samples are transferred to the inner hollow heated region 509 of the collecting electrode to transport them to the analyzer.

In a variety of embodiments for detecting collected the samples, the collecting electrode 507 can be configured allowing direct characterization using means other than thermal desorption and then detection. In one embodiment, the collecting electrode can be porous or non-porous materials that are suitable for direct characterization and analysis methods. The analysis methods could be, but not limited to, spectroscopic methods, such as Raman spectroscopy, FTIR, laser spectroscopy, and spectrometric methods, such as mass spectrometry and ion mobility based spectrometry, in particularly, spectrometric methods with sample introduction and ionization methods that are suitable for surface analysis, such as secondary ion MS (SIMS), desorption electrospray ionization (DESI)-IMS and/or -MS, DART-IMS and/or -MS, MALDI-IMS and/or -MS. As a non-limiting example, a gold surface on the collecting electrode can be prepared for direct measurement using surface enhanced Raman spectroscopy. Alternatively, particles with known size could be prepared (e.g. gold or silver coating) for chemical reaction and/or sample collection before being entrained with carrier gas and enter the electrostatic precipitator unit; in this case, the collected (gold coated) particles can analyzed using surface enhanced Raman spectroscopy and/or other analytical methods. Spectroscopic measurement can be conducted either on-the-fly (during collection process) and/or off line (after collection process). As a non-limiting example, one or more chemicals and/or matrix can be applied on the collecting electrode prior or after the collection step; such chemical can be used for detection or separation of collected samples. Alternative, samples collected on the collecting electrode can also be harvested for further analysis and characterization by any analytical instruments.

When the AC waveform is asymmetric, the period of the waveform has a segment that is positive polarity and a segment that is negative polarity. A segment is that time during the waveform with a given polarity there are two segments (one for each polarity) during a cycle of the AC waveform. The magnitude of the positive electric field is different from the magnitude of the negative electric field. In addition, the duty cycle (defined as the fraction of time with positive polarity divided by the fraction of the time with negative polarity) is different from 1. By adjusting the ratio of the positive field magnitude to the negative field magnitude, while also adjusting the duty cycle, it is possible to have asymmetric fields with substantially zero average field.

In yet another embodiment of the invention, it is possible to collect particulates on the same electrode that serves as the corona electrode. This is not possible with the conventional technology. If the AC waveform is such that the duration of the low voltage is longer than what is needed to produce zero average field, the particulates will on the average drift towards the center electrode. That is, if the average electric field has a direction that is opposite from the direction of the field during the corona phase, the particulates would be collected by the central electrode (the same that is the corona electrode during a fraction of the cycle). Using the corona electrode as the collection electrode minimizes the size of the device.

A system for particulate charging includes a set of electrodes energized with an AC waveform; and only one polarity of ions exist in the device from an ionization source during only one of the segments of the AC waveform and there is substantially no ions during the remainder of the AC waveform of opposite polarity. As common implementations, a corona, radioactive and/or an electrospray ionization source may be used. The AC waveform may be an asymmetric waveform, wherein after a cycle of the AC waveform there is no net electric induced particulate motion. When corona ionization source is used, the corona can be either positive or negative; preferably the corona is a negative corona. A collecting electrode that serves as a corona electrode during a fraction of the AC waveform. The electrostatic precipitator can be either a single- or two-stage precipitator. In the later case, a second stage to collect the particulates. The electrostatic precipitator can be used with an ion mobility and/or mass spectrometer based analyzer.

A particulate charging method, involves charging a particulate gaseous stream; applying a electric field in AC waveform; inducing ions from an ionization source during a fraction of the AC waveform; and not inducing ions from the ionization source during a fraction of the AC waveform of a opposite polarity. The step of applying a AC waveform in a frequency such that the particulates will not experience a substantial electric drift during each fraction of the AC waveform. A duty cycle of a segment that induces ions from an ionization source during a non-ionization fraction is adjusted to substantially decrease the deposition of the particulates on either electrode in a charging section. The method further involves collecting particles and the step of collecting particles during charging is minimized. Heating the collected particles in order to vaporize the particles and sub-sequentially analyzing the particles and/or vapors allow identifying chemical components in the particles.

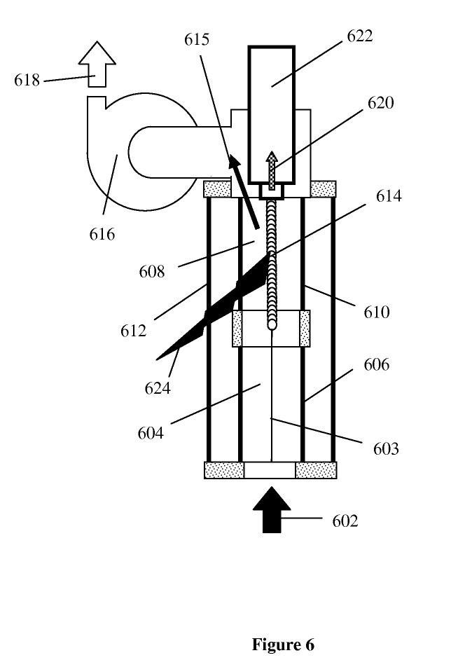

In a variety of embodiments, the electrostatic charging apparatus can be used in-conjunction with other analytical instruments such as an ion mobility based spectrometer. FIG. 6 shows non-limiting example, a sample flow 602 entering the charging stage 604 where a high voltage electrode 606 is set a positive potential for charging the particles. A thin wire electrode 603 at ground potential is used to generate corona and charge particles. The collection stage 608 has a negative high voltage electrode 610. These two high voltage electrodes are protected with grounded housing 612. A particle collector 614 is located in the collection stage region 608. This particle collecting electrode 614 can also be heated during desorption. At least one pump 616 is used for high flow rate sampling; via a flow path 615, the flow is exhausted with a purge flow 618. The particles collected on 614 are desorbed into an analyzer via a concentrated sample flow 620. The sample flow is directly pumped into the IMS during thermal desorption. This concentrated sample flow 620 can be directed to an analyzer 622 such as, but not limited to an analytical instrument, an ion mobility spectrometer, a mass spectrometer, a detector, a sensor unit, GC. Alternatively, the collected particles on collecting electrode 614 could be directly analyzed using non-structive spectroscopic methods, such as Raman spectroscopy. In this case, a laser beam 624 could be directed to measure collected particles. Optionally, the particles can also be analyzed by thermal desorbing them into an IMS after the Raman measurement.

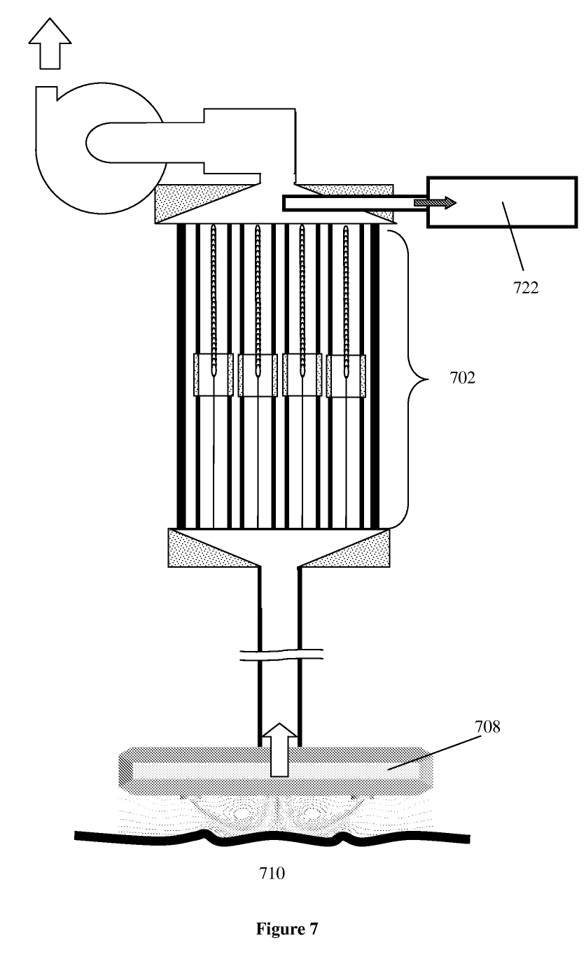

In another embodiment, the electrostatic charging apparatus can have a plurality of charging and/or collection stages. For example, FIG. 7 shows four charging and collection stages 702. The analyzer 722 can be an analytical instrument, an ion mobility spectrometer, a mass spectrometer, a detector, a sensor unit, GC, but not limited to these. FIG. 7 also depicts a particle sampling component 708 used to dislodge chemical vapors and/or particles from a targeted surface 722.

In a variety of embodiments, the electrostatic charging apparatus can be integrated into any particle sampling device, such as but not limited to the handheld wand sampling form. The handheld wand can have many different configurations. The first having a sampling component, for sampling and preconcentration of chemicals in both particle and vapor form. This sampling configuration will allow for collecting explosives onto an electrostatic charging section that is compatible with the current trace detection systems. The samples collected from the wand on the electrostatic charging section could then be thermally desorbed into a detection/analyzer system (an analytical instrument, an ion mobility spectrometer, a mass spectrometer, a detector, a sensor unit, GC, but not limited to these). Secondly, a handheld wand configuration with electrostatic charging section whereby the handheld wand is integrated with an onboard ion mobility based detector or other detection method, without significantly increasing the size and weight, could be optimized to detect explosives and other chemicals with higher systemic sensitivity compared to the portal systems.

One embodiment of the present invention is a dynamic inspection method that enables direct sampling of particles and/or vapors on the human body, packages, vehicles or other surfaces. The described chemical sampling and detection method is capable of releasing and extracting particles and vapors from the surface, preconcentrating these samples in the sampler's a electrostatic charging section, and/or detecting them in a few seconds with the onboard detection method, e.g. ion mobility spectrometer (IMS). It uses an air pump or pumps to generate both impinging and collecting air flows. Continuous or pulsed air jets are combined with adjacent suction ports to release and collect particles from clothing. In addition, with the handheld wand configuration, vapors can also be collected from the inner layer of the fabrics.

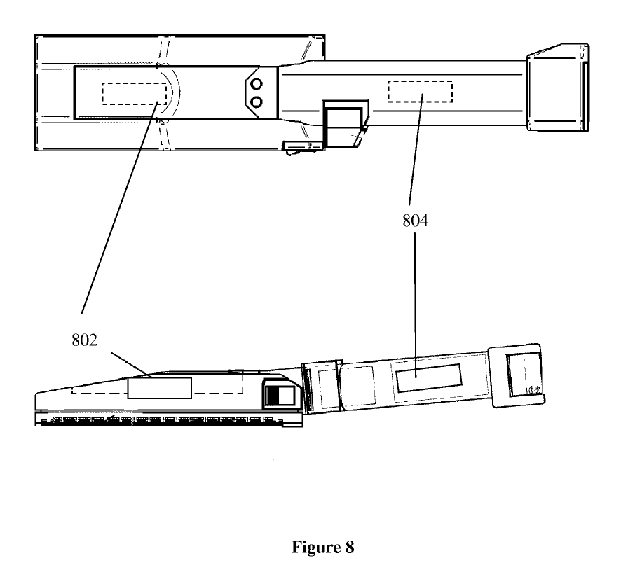

One embodiment of the present invention has the electrostatic charging section integrated into the handheld wand design. As shown in FIG. 8, the electrostatic charging section can be part of the front sampling region 802 of the handheld wand. In addition, the electrostatic charging section could be incorporated into the handle portion 804 of the handheld wand.

In yet another embodiment of the invention, the use of a DC corona for the collection of particulates to be analyzed in a mobility separating device is claimed. Appropriate operation of the gas flows, the electrodes voltage and the ion mobility spectrometer need to take place of best performance of the device. Thus, during the collection phase, large flows that introduce the sample to the electrostatic precipitator section (using either DC or AC waveforms) are used. During this time, the electrostatic precipitator is on, charging and collecting the particulates. After the sampling time, the flows are slowed down, and alternative or slower flows are used to introduce the sample into the detection unit. During this phase the gas flow rate is much lower than during the collection phase. The compounds are desorbed form the particulates by any means, including heating. During this phase the voltages in the electrostatic precipitator can be shut down or it can be kept on. If it is kept on, the corona can provide the charges required for ionization of the molecules of interest. AC fields used during this phase can prevent the deposition of the desorbed/ionized molecules on the electrodes. Unipolar ions can be obtained by using an asymmetric AC waveform, as proposed in for the collection of the particulates. The ions stored in the volume are then introduced into the mobility separating instrument. It is of importance to minimize the volume of the collection zone, in order to maximize the concentration of the molecules.

The discussion above uses a corona as the source of ions. Although corona is a straight forward method of manufacturing ions of a given species, the ionization comes at the expense of generation of noxious species, such as ozone in the case of air. Thus, an ion source that does not generate ozone would be highly desirable. There are multiple ionization sources, and it is the intention of incorporating them in the invention. In particular, electrospray ionization is one such source. Although electrospray operates best under conditions of steady state, the ions generated by the electrospray can be gated by the use of gating voltages, allowing passage of the ions to the charging state of the device during a fraction of the AC waveform in the charging stage. Other ions sources, such as plasma discharges, electron-beam, laser-or photon produced plasmas, could be also used.

A particle analysis system using an air flow that transports some particles into the system, an ionization source that charges the particles, at least one electrode that collects some of the charged particles under the guidance of a electric field, and an analyzer that analyzes the collected particles on the electrode. The analyzer is an ion mobility spectrometer and/or mass spectrometer. The analyzer can also be spectroscopic systems, such as a Raman spectroscopy. After collecting the particle sample using a single- or multiple-stage electrostatic precipitator, the collected particles may be introduced to the analyzer using a thermal desorber and a controlled air flow. Normally a low volume air flow (compared to the original sample flow) is used to deliver the desorbed sample to the analyzer. In case of analyzing the collected particles using spectroscopic method, the sample can be analyzed with in-situ. For example, a laser beam can aimed at the collecting electrode and measure the particles during or after the particle collection. There are a variety of source of particles that are entrained with the air flow in terms of air sampling. In one embodiment, a sampler that collects particles from a surface into a air flow.

A particle analysis method involves charging some particles in a gaseous stream, applying an electric field and collecting some particles in the gaseous stream on a electrode, and analyzing some of the particles using an analyzer. The method may include analyzing particles using an ion mobility spectrometer, mass spectrometer, and/or spectroscopic methods, including but not limited to; Raman spectroscopy, FTIR, and laser spectroscopy. These analytical devices could be used independently, sequentially, and/or simultaneously when analyzing the particles. These analytical devices could be during or after collecting the particles. In a variety of embodiments, the method involves introducing the samples into the analyzer with a thermal desorber and a controlled air flow. In one aspect, the particle collection and analysis method could be used with advance sample collection methods. The sample collection methods may involve sampling particles from a surface and collects the particles into an air flow. Many advanced sample collection methods also involve using contact and/or non-contact sampling methods involving dislodging particles from a surface, collecting them using a controlled air flow, delivering the air flow to the electrostatic precipitator and analyzer described in this invention.

In one embodiment, the non-contact interrogating and collecting apparatus have a front sampling region, at least one pair of facing sheet-like impinging air flows from an array of jet ports that release some sample from a targeted surface, at least some sample is collected at a intake port that is located interior and is in parallel to the pair of facing sheet-like impinging air flow ports, a critical angle of the impinging air flow administering the sheet-like impinging air flow and return air flow such that chemicals vapors and/or particles that are dislodged by the impinging air flow are suctioned with a return air flow into the intake port as a closed loop air current; and a electrostatic precipitator capturing particles in the return air flow by charging the particles and collecting them on an electrode under guidance of a electric field. Using this device, particle in a large volume of air could be preconcentrated on to the surface of collecting electrode. The electrode could remove from the sampling system and insert into analyzer for chemical identification. Alternatively, the sample on an electrode could be analyzed using a variety of surface analysis methods.

What is claimed is:

1. A system for particulate charging comprising:
(a) a set of electrodes energized with an AC waveform; and
(b) only one polarity of ions exist in the device from an ionization source during only one of the segments of the AC waveform and there is substantially no ions during the remainder of the AC waveform of opposite polarity.

2. The system of claim 1, wherein the ionization source is a corona.

3. The system of claim 1, wherein the ionization source is an electrospray.

4. The system of claim 1, wherein the AC waveform is an asymmetric waveform.

5. The system of claim 1, wherein after a cycle of the AC waveform there is no net electric induced particulate motion.

6. The system of claim 2, wherein the corona is a negative corona.

7. The system of claim 2, further comprises a collecting electrode that serves as a corona electrode during a fraction of the AC waveform.

8. The system of claim 1, further comprises a second stage to collect the particulates.

9. The system of claim 8, further comprises an analyzer.

10. The system of claim 9, wherein the analyzer is an IMS and/or a MS.

11. A particulate charging method, comprising:
(a) charging a particulate gaseous stream;
(b) applying a AC waveform;
(c) inducing ions from an ionization source during a fraction of the AC waveform; and
(d) not inducing ions from the ionization source during a fraction of the AC waveform of a opposite polarity.

12. The method of claim 11, wherein the step of applying a AC waveform in a frequency such that the particulates will not experience a substantial electric drift during each fraction of the AC waveform.

13. The method of claim 11, wherein a duty cycle of a segment that induces ions from an ionization source during a non-ionization fraction is adjusted to substantially decrease the deposition of the particulates on either electrode in a charging section.

14. The method of claim 11, further comprises collecting particles.

15. The method of claim 14, wherein the step of collecting particles during charging is minimized.

16. The method of claim 15, further comprises heating the collected particles in order to vaporize the particles.

17. The method of claim 16, further comprises analyzing the particles and/or vapors.

18. A particle analysis system, comprising:
(a) a air flow that transports some particles into the system;
(b) a ionization source that charges the particles;
(c) at least one electrode that collects some of the charged particles under the guidance of a electric field; and
(d) an analyzer that analyzes the collected particles on the electrode.

19. The apparatus of claim 18, wherein the analyzer is an ion mobility spectrometer.

20. The apparatus of claim 18, wherein the collected particles are introduced to the analyzer using a thermal desorber and a controlled air flow.

21. The apparatus of claim 18, wherein the analyzer is used to analyze the collected particles either during or after the particle collection.

22. The apparatus of claim 18, further comprises a sampler that collects particles from a surface into a air flow.

23. A particle analysis method, comprising:
(a) charging some particles in a gaseous stream;
(b) applying a electric field and collecting some particles in the gaseous stream on a electrode; and
(c) analyzing some of the particles using an analyzer.

24. The method of claim 23, wherein analyzing the particles is by using an ion mobility spectrometer.

25. The method of claim 23, wherein analyzing the particles is by using spectroscopic methods, including but not limited to; Raman spectroscopy, FTIR, and laser spectroscopy.

26. The method of claim 23, wherein analyzing the collected particles by introducing them into the analyzer with a thermal desorber and a controlled air flow.

27. The method of claim 23, wherein analyzing some of the particles can be conducted either during or after the particle collection.

28. The method of claim 23, further comprises sampling particles from a surface and collects the particles into an air flow.

29. A non-contact interrogating and collecting apparatus comprising:
(a) a front sampling region;
(b) at least one pair of facing sheet-like impinging air flows from an array of jet ports that release some sample from a targeted surface;
(c) at least some sample is collected at a intake port that is located interior and is in parallel to the pair of facing sheet-like impinging air flow ports;
(d) a critical angle of the impinging air flow administering the sheet-like impinging air flow and return air flow such that chemicals vapors and/or particles that are dislodged by the impinging air flow are suctioned with a return air flow into the intake port as a closed loop air current; and
(e) a electrostatic precipitator capturing particles in the return air flow by charging the particles and collecting them on an electrode under guidance of a electric field.
